(19) United States
(12) Patent Application Publication
(10) Pub. No.: US 2002/0136302 A1
(43) Pub. Date: Sep. 26, 2002

(54) Cascade window searching method and apparatus

(76) Inventor: Naiqian Lu, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/814,344

(22) Filed: Mar. 21, 2001

(51) Int. Cl. H04N 7/12

(52) U.S. Cl. 375/240.16; 375/240.12; 348/714; 348/716; 348/718

(57) ABSTRACT

A video compression technique is provided which reduces motion estimation computations. A digital signal processing system employs external memory. Detection speed is improved by loading a succession of refined search windows are loaded on-chip. By so doing, the search involves fewer accesses to external memory and so completes in a shorter amount of time.

### BACKGROUND OF THE INVENTION

This invention relates to the processing of video, and in particular to a window search technique for estimation of motion vectors.

Compressed video technology is growing in importance and utility. Analog or digital “NTSC-like” video transmissions require bit rates on the order 100 megabits per second. Compression technology today can reduce the required bit rate to less than 5 megabits per second. This is typically achieved using digital signal processing or VLSI integrated circuits.

Depending upon the ultimate bit rate and quality of the desired image, different types and levels of compression can be employed. Generally, the compression removes different types of redundancy from the video image being compressed. In doing so, the image is typically broken into groups of pixels, typically blocks on the order of 16 pixels by 16 pixels. By comparing different blocks and transmitting only information relating to the differences between the blocks, significant reductions in bit rate are achieved.

In addition, because some information within a block is imperceptible to the viewer, vector quantization or discrete cosine transforms can be used to remove bits corresponding to imperceptible or unimportant details. This further reduces the required bit rate, but may introduce certain degradation in the resulting image quality. A third technique for reducing the bit rate, and of primary focus here, is that stationary images, or moving objects, do not necessarily require retransmission of every detail. Motion compression techniques can be used to eliminate redundancies between frames. This is typically achieved by identification of a block of pixels which is considered “moved” between two frames. Then transmission of only the motion vector information, in place of all of the pixel data, effectively transmits the new location of the block for reconstruction at the decomposer.

In many video scenes, an object moves against an essentially unchanging background. In such circumstances, most of the background data can remain the same for frame after frame of the video data, with the foreground object being shifted and revised as needed. One such example is videoconferencing in which the overall room or setting for the videoconference remains essentially unchanged. In the foreground, however, individuals may be speaking or gesturing. For such applications it is desirable to perform a procedure known as motion estimation. In motion estimation, a vector is determined which relates the content of one video frame to the content of another video frame. For example, the vector might indicate the direction of motion of a portion of the contents of the earlier video frame. Use of such motion estimation enables video recording to use fewer bits. This is because the background portion of the scene can be characterized as having the same or almost the same data as the preceding frame, while the object in the foreground can be characterized as being essentially the same as an earlier frame, but moved to a new location.

FIG. 3 illustrates the motion estimation process. In FIG. 3b a current frame (picture) is shown, while FIG. 11 shows a reference frame. It is desired to characterize the content of the current picture as being the same as the content of the reference picture, but with a changing portion of the current picture, designated the “block” in the reference picture, together with a motion vector (u, v). The location of the block is usually given by the coordinates of its upper left corner, together with some information about its size.

One computationally intensive approach for determining the reference vector is to search the entire frame for the best fit. Using such procedure, every possible location for the block is determined, and the resulting motion vector computed. The motion vector chosen is the one that results in the best match between the estimated image and the current image. Such an approach, however, is computationally inordinately expensive, and is essentially impractical for ordinary use.

There are, however, various fast searching methods for motion estimation. These methods significantly reduce the computational cost of searching, but impose limitations. The essence of these approaches is to reduce the number of block search operations. These approaches can be characterized into two different groups—global search and step by step search. Each of these techniques is individually well known.

In global search approaches for determining the motion vector for a reference block, the system tries to find the best matching block in a frame of video information by moving around the frame at many widespread points and comparing blocks at those locations with blocks in the reference frame. The system tries to match a minimal area first, then refines the search in that area. An example is a three-step search. The system first searches to find a minimal point (point of least difference), then searches blocks that are two pixels away from the minimal point. Finally, the system searches the blocks that are next to the new minimal point. The particular values, of course, can be adjusted for different applications. The average number of operations in this type of global search is on the order of 40. In this method, every possible motion vector in the searching area is checked and compared. The motion vector with the lowest Sum of Absolute Difference value (SAD) of the two compared image blocks is selected, and coded. The result is that a high compression ratio is achieved.

The advantage of such an approach is its ability to quickly approach the minimal area. For fast moving video images, this is important because the matching block may be a relatively long distance, for example, 10 pixels, away from the previous point. The global approach also makes searching time more predictable, because the global search always performs the same number of operations, even if the match is found on the first try.

A second fast search technique is the step by step search. In many types of video, for example, a videoconference environment, the background does not move, and the speaker does not move dramatically. If the encoder has enough computational resources, and encoding at a sufficient rate, for example, more than 10 frames per-second speed, the matching block likely will be found two or three pixels away. Step by step searches from the center thus may provide better results than a global search. One typical example of a step by step search is the diamond search. It begins searching from the center of the window, compares four neighbors (up, down, left, and right), and then selects the best match as the new center. The searching continues until the center does not further change.

In a videoconference environment, objects usually move very little from frame to frame. Typically, if the frame rate on the encoder is faster than 10 frames/second, most movement will be less than four pixels on a CIF image. This step by step search method yields better results in such condition than many other fast searching methods. It is also the best method for processing a background image block because such a block will not move during videoconferencing.

Motion estimation is used in most of the video compression standards, including MPEG (motion picture experts group) H.26X, and so on, to compress the video stream. As can be seen, the searching process discussed above is a time consuming, computationally intensive task. The process consumes much of the processing power of a CPU (central processing unit). In addition, large numbers of memory accesses are required due to the nature of the computations.

Systems employing such video compression and detection methods typically use a digital signal processor as the number-crunching workhorse. DSPs typically DRAM (dynamic random access memory) and SDRAM (synchronous DRAM) memories. SDRAMs are preferred to reduce system cost and for their low power consumption. A cache is used with these memories in order to eliminate the extra clock cycles needed to access these memories for reading and writing. However, cache memory is a limited resource in DSPs. Consequently, there is only so much room for program segments and data. If the cache contains program code, and a block of data is required, it is likely the cached program code will be flushed to accommodate the incoming data. Vice-versa, when a segment of code is needed, any data already resident in the cache is likely to be flushed. Typically, DSPs do not have control over the cache operation, and so performance can be severely degraded when processing video data, due to constant caching and re-caching of program and data.

Accordingly, there is a need to improve the performance of DSPs. There is a need to compensate for the performance hit resulting from the use of a caching scheme in certain memory configurations.

### SUMMARY OF THE INVENTION

According to the invention, a method and apparatus is provided for video compression. A digital signal processor (DSP) is provided with program codes to compress a current frame of video information. A portion of a search window on the current frame is loaded into on-chip memory contained in the DSP. A search for a first level search point is made by comparing a reference block against search points in the portion of the search window contained in the on-chip memory. A second portion of the search window may be loaded depending on the location of the first level search point. A refined search is made on the second portion.

The present invention increases the video compression process substantially by the initial loading step. Consequently, the video compression time is improved by the present invention.

### BRIEF DESCRIPTION OF THE DRAWINGS

The teachings of the present invention can be readily understood by considering the following detailed description of illustrative examples of embodiments of the invention, in conjunction with the accompanying drawings:

FIG. 1 is a flowchart illustrating a preferred embodiment of the method of this invention;

FIG. 2 is an example of one implementation of a preferred embodiment of the method of this invention;

FIG. 3 illustrates a conventional motion estimation process; and

FIG. 4 shows an illustrative example of a DSP configuration in accordance with the invention.

### DESCRIPTION OF THE SPECIFIC EMBODIMENTS

H.263 is the video coding algorithm mandated for use in complying with videoconference standard H.323 and H.324. These standards have been put forth by the International Telecommunications Union (ITU). Using H.263 to compress a video stream substantially reduces the bandwidth requirement for transmission of the compressed video signal. Typical compression ratios are 100:1 to 200:1. To achieve this high compression ratio, the computational load on the encoder is high.

The H.263 algorithms consist of two parts: coding and motion estimation/compensation. The greater demand for computational power comes from the motion estimation/compensation portion. About 70 to 80 percent of the computational tasks come from this portion in a typical encoder. To reduce the computational task, a new searching process described below is used.

To reach more than 100:1 compression ratio, H.263 compares the data blocks which constitute two frames—a previous image and the current image—to determine the difference. Only the difference is coded and sent; it being assumed that the previous frame is already at the receiver. Furthermore, the algorithm tries to determine if the image is moving, how far it moved, and in which direction. The procedure is called motion estimation. If this method is applied globally, by making detailed comparisons across the entirety of the two images being compared, there is a prohibitively high computation cost. For every 16×16 image block, searching in 48×48 window, 961 sum of absolute difference comparisons are necessary. More than 95% of the encoding time is used for this single operation.

An example is a three-step search. The system first searches to find a minimal point (point of least difference), then searches blocks that are two pixels away from the minimal point. Finally, the system searches the blocks that are next to the new minimal point. The particular values, of course, can be adjusted for different applications. The average number of operations in this type of global search is on the order of 40.

In one embodiment of the invention, the data blocks of the frame which constitute the entire search area is loaded into the on-chip memory of the DSP. For example, in accordance with H.263, nine blocks of image (48×48) are loaded into DSP memory. An average search will access thirty to forty blocks. By loading nine blocks of window data onto on-chip memory of the DSP, substantial time is saved by avoiding the numerous external memory accesses that would be needed. The user can expect over 70% improvement in the search speed by performing the search on-chip.

Lower system cost requirements and increasing demand for smaller package size are introducing DSPs with smaller on-chip memory. For example, it is not uncommon for a DSP to have 2K of on-chip memory in its X or Y space. However, a 48×48 search window requires 2.25K words of memory (1K=1024). Consequently, in some DSPs hosting an entire search window is not feasible. A simple partial window load into the on-chip memory of such a DSP will not work because the minimum point, which is not known a priori, may be located in the portion of the window that has not been loaded into the on-chip memory.

Thus, in accordance with another aspect of the invention, a technique for window searching includes a first pass in which the data blocks constituting a first portion of an image frame is loaded from external memory into the on-chip memory, e.g., either the X space or the Y space. The first portion corresponds to a portion of the search window. A first search is made on the search points contained in the first portion, including computing the motion vectors (e.g., SADs) of the search points. The search continues with the remaining search points of the window which had not been loaded into the on-chip memory, by computing the motion vectors of the search points residing in external memory. In a subsequent step, the search is refined in a smaller area. This general outline describes an aspect of the invention for fast motion search where the on-chip memory of a DSP cannot accommodate a full window search. Following is a more detailed discussion.

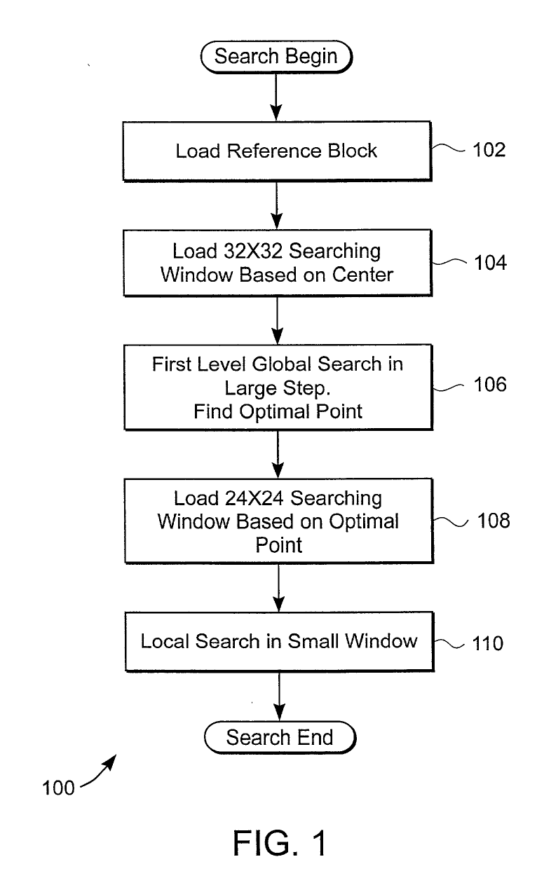

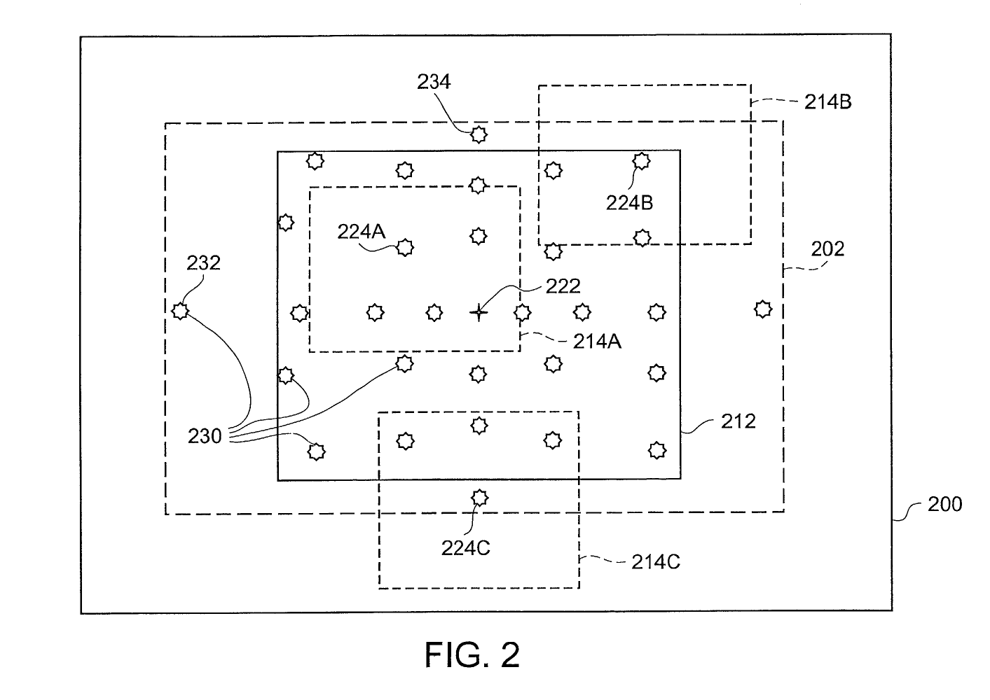

FIGS. 1 and 2 show an illustrative example of an embodiment of the invention. The flow chart 100 shows the processing steps in accordance with the invention for searching a current frame 200 of a video image (video signal, and so on). At step 102, a reference block (e.g., 302, FIG. 11) of a reference frame is loaded into the DSP. The reference block is typically going to be an earlier frame of video, but this is not necessarily so. There are two basic motion prediction methods in video compression. The P frame method uses a previous frame ahs the reference frame. Most of the time this is going to be the last frame. However, it can be an earlier frame if an error happened in the last frame.

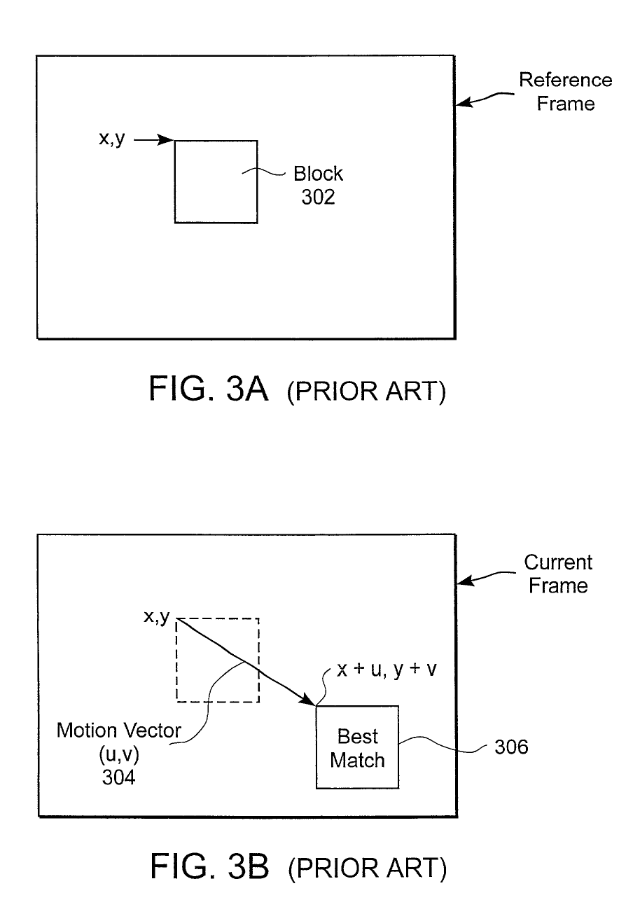

Motion vectors (e.g., 304, FIG. 3b) relative to the reference block 302 are computed for candidate blocks 306 in the current frame. These candidate blocks are selected in accordance with a search window comprising a pattern of search points (e.g., 230, FIG. 2) which correlate to coordinates in the current frame.

In step 104, a first portion 212 comprising a 32×32 block of image data from the current frame is loaded into the on-chip memory of the DSP. As can be seen in FIG. 1, a conventional search window 202 comprises an area of the current frame that is large enough to encompass all of the search points 230. However, the portion 212 contains fewer than all of the search points, some of the search points lying outside of the portion; e.g., points 232 and 234. Preferably, the size of the first portion is such that most of the search points lie inside of it. The choice of a 32×32 window is not critical to the practice of the invention, however. The size depends primarily on the available size of the on-chip memory, and thus may be larger or smaller. While it is preferable to have a larger window, it will be shown that the invention can still realize improved performance with smaller window sizes.

Next, motion vector calculations (e.g., SAD) are made during a global search, step 106. Here, the motion vectors between the initial center point 222 and each of the search points 230 is computed. For those search points contained in the portion 212, the computations will proceed with no external memory access delays, since the data is resident in the on-chip memory of the DSP. Consequently, there are no external memory access operations during this portion of the processing. Internal memory access consumes one clock cycle, while external memory accesses typically require many times more clock cycles to complete. This represents a significant savings in time.

The search step 106 continues for the search points that are outside of the portion 212. At the end a minimum vector from among all of the search points 230 (external and internal to the first portion) is determined. The search point associated with the minimum motion vector is referred to as the first level search point. In performing the motion vector computations for the exterior search points (e.g., 232, 234), there will be some delay (i.e., memory access delay) by virtue of those points not having been loaded into the DSP's on-chip memory. However, the delay is compensated for by the time savings realized during processing of the search points inside the portion, where external memory access was not required.

Different search algorithms have different patterns of search points. The search pattern of FIG. 2 is shown merely for illustrative purposes and is not intended to indicate a preferred search pattern. It can be seen that the size of the portion 212 for any given search pattern must be selected so that the portion fits in the available DSP on-chip memory. By virtue of loading any portion of the search window into the on-chip memory and performing a search using the data stored on-chip will result in an improvement in processing time.

Continuing with FIG. 1, the first level search point, namely, the search point with the smallest associated motion vector becomes the new center point for a subsequent refined search window. The refined window search uses a smaller window to perform the next level search. There are three outcomes to consider. In the first case, the first level search point is located well within the area of the first portion 212. In this case, the first level search point is located such that the smaller window used for the refined search lies completely within the first portion. For example, if the first level search point is the search point 224A, then the smaller window 214A for the refined search is centered around it. As can be seen, the smaller window lies totally within the first portion 212. Thus, all the data points needed during the refined search are contained in the first portion. Since the first portion has already been loaded into the on-chip memory, then the data is already available within the DSP to perform the refined search.

In the second case, the first level search point lies near the boundary of the first portion 212. Consider, for example, the search point 224B which lies near a boundary of the first portion. Centering the smaller window about the search point 224B for the refined search requires data points which lie outside the first portion. These data points reside in external memory and so the refined search will require accessing external memory.

In the third case, the first level search point lies outside of the first portion 212. The search point 224C illustrates this scenario. Not unlike the second scenario, the smaller window 214C for the refined search calls for some data that is not already stored in the on-chip memory of the DSP.

Referring back to FIG. 1 then, step 108 is provided where the first level search point is located as described in the second and third scenarios. In this step, the portion of the current frame comprising the smaller search window is loaded in from the external memory. In the example shown in FIG. 3, data for a 24×24 window 214 (A, B, or C) centered around the first level search point, which is now the new center point, is loaded in from external memory. The data comprising the first portion 212 residing in the on-chip memory can be overwritten by the data of the smaller window, but this is not necessary. As with the 32×32 window, there is no special significance with the 24×24 size selection of the smaller window. The window size for the smaller search window, however, should be sufficient to cover the range called for by the particular search algorithm in use.

Finally, in step 110 the refined search is performed. For example, in a conventional three-step search, four data points coincident with the four compass points centered about the new center point are searched to identify a second level search point. Typically, the data points that are two pixels away from the new center point are searched. Next, the eight points which constitute the 3-pixel×3-pixel square centered around the second level search point are searched. This completes the full pixel motion search of the present invention.

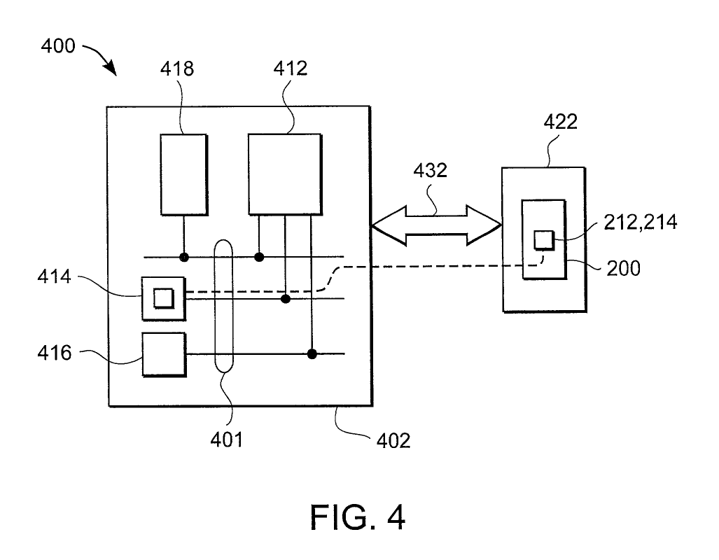

Referring to FIG. 4, a block diagram shows an illustrative example of an embodiment of a processing apparatus 400 in accordance with the invention. A DSP unit 402, or similar processing device, is coupled to an external memory device 422. Data communication between the DSP and external memory occurs over a data bus 432. The DSP includes an arithmetic processing unit 412 comprising a block of logic for performing arithmetic and like operations commonly associated with DSPs. The DSP further may include an on-chip read-only memory (ROM) 418, containing the firmware (program code) for operating the DSP. Conventionally, an X-space memory 414 and a Y-space memory 416 are provided on-chip in the DSP; however, other memory configurations are possible. A set of internal buses 401 interconnect the various components.

The current frame of video 200 is stored in the external memory 422. In accordance with the invention, portions of the current frame 212 or 214 are loaded into the on-chip memory of the DSP. In the illustrative block diagram of FIG. 4, the frame portions are shown loaded into the X-space memory 414, though the Y-space memory 416 could be used to accommodate the frame portions.

The DSP includes firmware or the like, typically contained in a ROM, which includes program codes to perform the foregoing processing described in conjunction with FIGS. 1 and 2. The disclosed processing is sufficient to enable one of ordinary skill in the relevant arts, including the programming and video processing arts, to provide the proper coding to configure the DSP for use in accordance with the invention. The specific coding conventions and data structures depend on factors such as the operating environment, the development environment, and the target devices which will use the inventive aspects described herein. Since such details are not germane to the invention they have been omitted to simplify the discussion.

Although specific embodiments of the invention have been described, various modifications, alterations, alternative constructions, and equivalents are also encompassed within the scope of the invention. For example, the disclosed embodiment of the invention is based on DSP technology. DSP's are the preferred choice of processor in many consumer products. DSP's are generally tailored for number crunching applications, such as video processing. However, the disclosed invention is not restricted to operation within any specific data processing environment, but is free to operate within a plurality of data processing regimes. Although the present invention has been described in terms of specific embodiments, it should be apparent to those skilled in the art that the scope of the present invention is not limited to the described specific embodiments.

The specification and drawings are, accordingly, to be regarded in an illustrative rather than a restrictive sense. It will, however, be evident that additions, subtractions, substitutions, and other modifications may be made without departing from the broader spirit and scope of the invention as set forth in the claims.

What is claimed is:

1. In a digital signal processor (DSP), a method for motion detection in a current frame of video information, comprising:
providing a search window which defines a search area of data points of said current frame, said search window defining a pattern of search points located in said current frame;
loading a reference block into a first memory portion of said DSP;
loading at least a first frame portion of said search area into a second memory portion of said DSP, said first frame portion including at least some of said search points;
determining a first level search point including performing comparisons of said reference block with search points in said first frame portion;
selectively loading a second frame portion of said search area into a third memory portion of said DSP based on a location of said first level search point; and
performing a local search relative to said first level search point.

2. The method of claim 1 wherein said determining further includes performing a comparison of said reference block with at least one search point that is stored in a memory that is external to said DSP.

3. The method of claim 1 wherein said local search includes providing a second search window centered about said first level search point, said second search window defining a refined search area contained within said search area of said current frame.

4. The method of claim 3 wherein said loading a second frame portion is performed if said refined search area includes data points not contained in said first frame portion.

5. The method of claim 1 wherein the first, second, and third memory portions are portions of an on-chip memory of said DSP.

6. The method of claim I wherein said third memory portion is contained within said second memory portion.

7. The method of claim 1 wherein said performing comparisons includes producing motion vectors.

8. The method of claim 7 wherein said first level search point is determined based on said motion vectors.

9. The method of claim 1 wherein said performing comparisons include calculating sum of absolute difference values.

10. The method of claim 1 wherein the entirety of said search area is loaded into said second memory portion.

11. A method for video compression by comparing a first frame of video information against a second frame of video information, comprising:
identifying a reference frame contained in said first frame;
storing said second frame in a first memory;
defining a search area in said second frame, said search area comprising data points in said second frame, said search area including plural search points;
storing at least a portion of said search area into a second memory, including one or more of said search points;
comparing said reference block to search points contained in said second memory;
determining a first level search point based at least on said step of comparing;
defining a refined search area centered about said first level search point, said refined search area being contained in said search area; and
performing a local search on said refined search area.

12. The method of claim 11 wherein said performing a local search includes selectively loading data comprising said refined search area into said second memory.

13. The method of claim 12 wherein said step of selectively loading data is performed if said refined search area includes locations not contained in said first frame portion.

14. The method of claim 11 further including an additional step of comparing said reference block to search points which are contained in said first memory and which are not contained in said second memory, said determining further based on said additional step of comparing.

15. The method of claim 11 wherein said steps are performed in a digital signal processor.

16. The method of claim 15 wherein said first memory is external to said digital signal processor and said second memory is an on-chip memory contained in said digital signal processor.

17. The method of claim 11 wherein said comparing includes producing motions vectors and said first level search point is determined based on said motion vectors.

18. The method of claim 11 wherein said comparing includes calculating sum of absolute difference values.

19. The method of claim 11 wherein the entirety of said search area is stored in said second memory.

20. In a digital video image compression system, a device for estimating motion, comprising:
a processor;
a first memory coupled to said processor for storing a current frame; and
a second memory coupled to said processor, wherein said second memory stores a sequence of instructions which, when executed by said processor, cause said processor to perform steps of:
(i) accessing a search window which defines a search area in said current frame, said search window defining a pattern of search points in said current frame;
(ii) loading a reference block into a first memory portion of said DSP;
(iii) loading at least a first frame portion of said search area into a second memory portion of said DSP, said first frame portion including at least some of said search points;
(iv) determining a first level search point including performing comparisons of said reference block with search points in said first frame portion;
(v) selectively loading a second frame portion of said search area into a third memory portion of said DSP based on the location of said first level search point; and
(vi) performing a local search about said first level search point.

21. The device of claim 20 said first memory is external to said DSP.

22. The device of claim 21 said second memory is on-chip memory contained in said DSP.

23. The device of claim 20 wherein said step (iv) further includes performing a comparison of said reference block with at least one search point that is stored in said first memory.

24. The device of claim 23 said first memory is external to said DSP.

25. The device of claim 20 wherein said performing comparisons includes producing motion vectors and said first level search point is determined based on said motion vectors.
